(19) United States
(12) Patent Application Publication
(10) Pub. No.: US 2007/0018898 A1
(43) Pub. Date: Jan. 25, 2007

(54) Small high frequency multiband antenna

(76) Inventor: Alan Ridgeway Orr, San Diego, CA (US)

Correspondence Address: Alan R. Orr, 11925 Meriden Lane, San Diego, CA, 92128, US

(21) Appl. No.: 11/485,608

(22) Filed: Jul. 12, 2006

Related U.S. Application Data
(60) Provisional application No. 60/698,148, filed on Jul. 12, 2005.

(51) Int. Cl. H01Q 9/00

(52) U.S. Cl. 343/745; 343/900

(57) ABSTRACT

A novel antenna system that uses tuned components in different unique combinations in order to tune an antenna system to frequency bands of interest. Compared to using unique components for each tuned frequency band this approach requires fewer components and consequently reduces cost for the antenna system, minimizes space requirements for the antenna system and greatly improves the number of tuned frequency bands possible. In addition, the resulting system can provide the tuned frequencies or bands through discrete means, such as push button, versus commonly used analog methods as employed in antenna tuners/systems (known to those skilled in the art). Furthermore, this antenna system provides the basis for a specific antenna system solution when connected to a handie talkie, HT or handheld scanner suitable for handheld use in the frequency bands between 3 MHz and 30 MHz, although easily extended by a person skilled in the art.

### CROSS-REFERENCE TO RELATED APPLICATIONS

This application claims the beneift of U.S. Provisional Application No. 60/698,148, filed Jul. 12^{th}, 2005.

### STATEMENT REGARDING FEDERALLY SPONSORED RESEARCH OR DEVELOPMENT

Not Applicable

### RERFERENCE TO SEQUENCE LISTING, A TABLE, OR A COMPUTER PROGRAM LISTING COMPACT DISC APPENDIX

Not Applicable

### BACKGROUND OF THE INVENTION

Some handheld radios or HT's (i.e. handie talkies) have high frequency radio reception, that is the ability to receive frequencies between 3 MHz and 30 MHz. This capability although not on all handheld radios is common. Some potential problems faced with creating an antenna system to receive high frequency radio signals using handheld radios while handheld are (1) the ability to tune many frequencies with a single antenna making it of high value to the user, (2) small size so it remains handheld, (3) light weight so the radio with antenna system remains handheld and (4) light weight so as not to unduly stress existing antenna mounts on handheld radios.

Note that the ability of the antenna system to tune frequency bands provides improved signal strength as compared to an antenna system without tuned frequency bands as known to those skilled in the art.

### BRIEF SUMMARY OF THE INVENTION

The invention reuses multiple components within the antenna system to achieve an order of magnitude more tuned frequencies than would be possible if the components were not reused. This is accomplished through sub-circuits containing the components and being combined using switches. The antenna system consequently overcomes potential problems faced for creating a high frequency antenna system for handheld radios. These potential problems overcome are (1) the ability to tune many frequencies with a single antenna making it of high value to the user, (2) small size so it remains handheld, (3) light weight so the radio with antenna system remains handheld and (4) light weight so as not to unduly stress existing antenna mounts on handheld radios.

For the preferred embodiment, 2ˆx tuned frequencies with the associated frequency bands are possible where there exists x individual tuned sub-circuits. If only the original tuned sub-circuits are used without reusing them in different combinations then only x primary tuned frequencies or tuned frequency bands occur. This assumes there is exactly one tuned frequency band of interest associated with each combination of sub-circuits. This invention consequently increases the signal strength drastically for far more than x tuned frequency bands, but rather 2ˆx tuned frequency bands, while keeping it potentially much smaller and of lower weight than if more than x sub-circuits were used.

### BRIEF DESCRIPTION OF THE SEVERAL VIEWS OF THE DRAWING

FIG. 1 is the top view of the PC board used in the antenna system.

FIG. 1A is a single connection point for a whip antenna.

FIG. 1B through 1F are 2 pin connection points for inductors each tuned to a high frequency band.

FIG. 1G through 1K are 6 pin connection points for each DPDT push button switch.

FIG. 1L is a connection point for a SMA connector.

FIG. 2 is the bottom view of the PC board used in the antenna system.

FIG. 2A through 2L are the same as described for FIG. 1A through 1L.

FIG. 3 is the 6 pin connection as looking down on the PC board with each pin labeled for reference.

FIG. 4 is the device housing or case FIG. 4A is a side view of the acrylic housing for the antenna system without push buttons shown.

FIG. 4B is the top view of the acrylic housing for the antenna system without push buttons shown.

FIG. 5 is a representation of the assembled antenna system with whip antenna collapsed on top and push buttons shown on side.

### DETAILED DESCRIPTION OF THE INVENTION

As used herein, “whip” refers to an antenna that is connected to the antenna tuner of the antenna system. Although not required, it could be collapsible.

As used herein, “antenna tuner” refers to the portion of the antenna system that tunes the system, most importantly tuning of the whip antenna, to frequency bands.

As used herein, “handheld” refers to the antenna system that can be used on a handie talkie that does not require additional structural supports other than the radio to which the antenna system is attached.

As used herein, “sub-circuit” refers to at least one or more inductors or capacitors that can be connected or disconnected to the whip through a single switch.

As used herein, “primary” refers to the single frequency band associated with each tuned sub-circuit if only that sub-circuit is connected to the whip antenna and radio through the associated switch being depressed.

As used herein, “tune” or “tuned frequency band” or “tuned frequency bands” refers to a range of frequencies that exhibit a SWR, where SWR stands for standing wave ratio, is known to those skilled in the art, that is less than 12.0.

As used herein “handie talkie”, “HT” or “handheld scanner” refers to a radio that can be used handheld. The antenna system as mentioned herein is connected to the radio's antenna connector.

As used herein “controlled manually” refers to users selecting, on an individual basis, which sub-circuits are to be connected to the whip antenna.

As used herein “fixed inductance” refers to sub-circuits that contain fixed value inductors or variable inductors that are set to the desired fixed inductances to obtain the appropriate tuned frequency band.

The antenna system of the preferred embodiment is made for a handheld radio, also known as a handie talkie, HT or handheld scanner. The device is intended for the high frequency radio spectrum below 30 MHz and above 3 MHz. The sub-circuits, through use of push button switches are combined in 2^{x} distinct combinations each having a corresponding tuned frequency band. “x” refers to the number of push button switches that each have an associated sub-circuit. The preferred embodiment has 5 sub-circuits and consequently 5 push buttons although this number is arbitrary, as known to those skilled in the art, with more sub-circuits providing greater capability. There are consequently 2ˆ5 or 32 sub-circuit combinations and associated tuned frequency bands. Since the components for 5 versus 32 sub-circuits are required the size and weight are sufficiently small to make this embodiment antenna system supported by a handheld radio while used handheld.

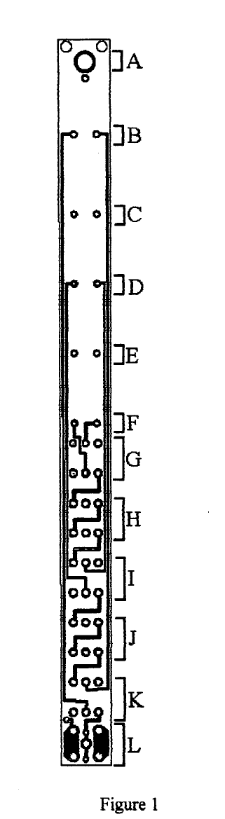

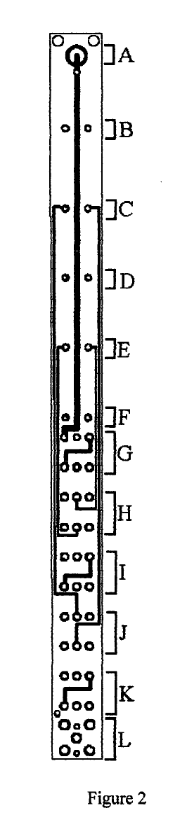

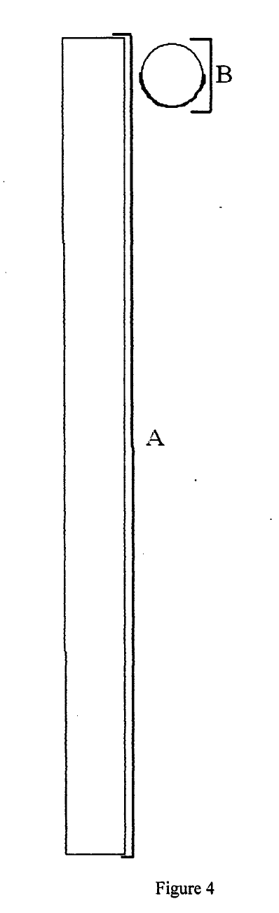

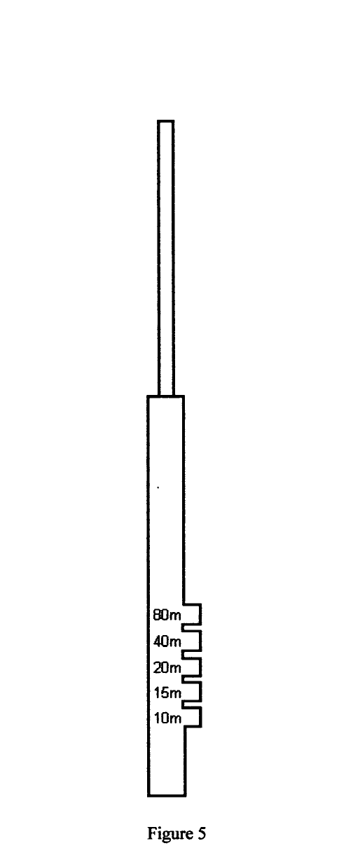

The antenna system attaches to the RF connector at the top of the radio. In FIG. 1 a connection is made between the radio and the center PC board trace/wire at location L. The antenna system housing contains the sub-circuits. The sub-circuits are variable inductors, specifically they are variable inductors with a standard 7 mm housing, known to those skilled in the art. The value for each inductor is set or fixed when the device is made such that the antenna system is tuned to the desired tuned frequency band when the associated sub-circuit switch is depressed. In other words, variable inductor values are not intended to be changed by end users. The inductors connect to the PC board through the holes at locations B, C, D, E and F in FIGS. 1 and 2. Two pole double throw push button switches are used and are attached to the PC board through the holes at locations G, H, I, J and K in FIGS. 1 and 2. The housing or case extends beyond the top and bottom of the PC board enough to allow support for a whip antenna above the housing and a SMA plug which connects to the radio and is connected to the bottom of the housing. The PC board in FIGS. 1 and 2 measures 5.75″ high by 0.406″ wide, The PC board slides into the ½″ inside diameter round acryllic pipe housing or case. The switches and inductors are inside the case except for the user accessible buttons which manually connect or disconnect the sub-circuits to the whip antenna The housing is represented in FIG. 4A. Different housings made of different materials can be used with potentially different tuned frequency results as could be determined by those skilled in the art. The antenna attaches to the PC board, using a connector, at location A in FIGS. 1 and 2. Ideally the radio has a SMA jack, also known as a female SMA connector since for the preferred embodiment a SMA connector is attached to the PC board at location FIG. 1L and FIG. 2L. The antenna system can also be easily connected to other radio connectors as long as an adapter is used to convert the SMA connector. Examples of other connectors for which adapters can be easily purchased are BNC, UHF jack or PL-259 jack. The overall size of the housing is 7 and 9/16″ in length and 11/16″ in diameter not including the height of the push buttons for the diameter and excluding the whip antenna for the height. The length increases to 12 and ¾″ with the whip antenna attached and collapsed. With the antenna extended the length increases to a total of 40 and ¼″. The overall size of the device can be varied by those skilled in the art. Note that FIG. 5 depicts a representation of the antenna system with the buttons and whip connected. Note that in FIG. 5, the buttons are labeled with 80 m, 40 m, 20 m, 15 m and 10 m which correspond to the 80 meter ham band, 40 meter ham band, 20 meter ham band, 15 meter ham band and 10 meter ham band. These frequency bands are represented in wavelength and can be easily converted to the frequencies represented in megahertz by one skilled in the art.

The antenna system tunes 5 primary frequency bands each using one sub-circuit. These primary frequency fall within the range of high frequency ham bands of 3.8 MHz to 30 MHz. A previous prototype was developed with the 5 primary tuned frequency bands, each using one sub-circuit, including 5 shortwave bands below 30 MHz and above 3 MHz. The primary tuned frequency bands are selected arbitrary. The fixed inductances for each sub-circuit are chosen to make the antenna system tune to frequencies within the primary tuned frequency bands. For the preferred embodiment, the tuned frequencies within each primary tuned frequency band are 28.7 MHz, 21.04 MHz, 14.12 MHz, 7.0 MHz and 3.95 MHz. The primary tuned frequencies could be easily changed by one skilled in the art by changing the associated inductances for each sub-circuit which also changes the corresponding tuned frequencies.

Each primary frequency band is achieved by depressing the associated push button or turning “on” one of the 5 manual switches which engages only the single associated tuned sub-circuit which tunes the antenna system to the associated frequency band.

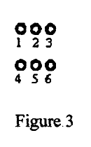

Each sub-circuit contains one inductor. One inductor is associated to each push button switch. When the switch is up or not depressed the switch connects pins 6 to 4 and 3 to 1 thereby bypassing the inductor which connects to pins 2 and 5 in FIG. 3. Note that the pins are labelled as if looking down on the top of the PC board. When the switch is depressed, the switch routes the radio signal by connecting pins 6 and 5 in addition to 2 and 1 thereby engaging/including the associated inductor as part of the tuned antenna system. For signal reception, the signal is routed from the whip antenna through all sub-circuits or inductors that are on or engaged and then to the radio. For signal transmitting, to which this invention could be extended by those skilled in the art, the signal path is in the reverse direction.

The antenna system combines multiple sub-circuits in series by having the associated buttons of the multiple sub-circuits depressed and undepressed. The various combinations sub-circuits through depressed and undepressed push buttons produces 2^{x} tuned frequency bands where x is the number of switches associated to sub-circuits. In this case there are 5 push buttons producing 32 combinations with the associated tuned frequency bands. Adding the ability to connect sub-circuits in parallel would add additional capability if needed to the antenna system as could be done by one skilled in the art.

For this embodiment where the inductors are connected in series based upon switches depressed and associated with each sub-circuit, the switches are arranged based upon the primary tuned frequency band, from low to high. In this arrangement, it is intuitive that lower frequency associated switches will cause a greater change in the tuned frequency band and higher will impact the tuned frequency band less. This leads to intuitively successful selection of switches for non-primary tuned frequency bands with practice without having to necessarily lookup the switches to be depressed within a table.

If desired, by one skilled in the art, adding variable tuning capability adjustable by the user, versus fixed tuning, could be done for each sub-circuit or after all sub-circuits have been combined. This would allow a better match at the exact frequency of interest as well as extending the usuable band of frequencies that the antenna system can tune. For this embodiment, performance is good considering considering tuned frequency band bandwidths with acceptable SWR's, so this additional complexity and associated cost is left out.

The embodiment discussed has a tuned frequency and consequently a tuned frequency band for each of the 2≡switch combinations since 5 switches. Examples of these tuned frequencies with each having a tuned frequency band are as follows. With only the push button depressed for the switch at location K in FIGS. 1 and 2 the associated sub-circuit is connected between the radio and whip and tunes the system to 28.70 MHz with a SWR of 2.3.

With only the push button depressed for the switch at location J in FIGS. 1 and 2 the associated sub-circuit is connected between the radio and whip and tunes the system to 21.04 MHz with a SWR of 1.5.

With only the push button depressed for the switch at location I in FIGS. 1 and 2 the associated sub-circuit is connected between the radio and whip and tunes the system to 14.12 MHz with a SWR of 2.6.

With only the push button depressed for the switch at location H in FIGS. 1 and 2 the associated sub-circuit is connected between the radio and whip and tunes the system to 7.0 MHz with a SWR of 4.7.

With only the push button depressed for the switch at location G in FIGS. 1 and 2 the associated sub-circuit is connected between the radio and whip and tunes the system to 3.95 MHz with a SWR of 5.5.

With push buttons for switches, at location K and J, depressed the tuned frequency of the combined in series sub-circuits is 16.01 MHz with a SWR of 2.6.

With push buttons for switches, at location I and J, depressed the tuned frequency of the combined in series sub-circuits is 11.86 MHz with a SWR of 3.0.

With push buttons for switches, at location H and G, depressed the tuned frequency of the combined in series sub-circuits was 3.55 MHz with a SWR of 6.0.

Note that a MFJ-259B SWR Analyzer was used for calibration and readings for each sub-circuit containing a variable 7 mm can inductor that is associated with each switch. The analyzer was used as well for the antenna system SWR measurements described. The switches used are push button DPDT with undepressed and depressed connections as discussed previously in association with FIG. 3.

Certain aspects of the preferred embodiment can be easily extended, as known to those skilled in the art, such as extending the frequency range of the antenna system beyond the high frequency range of 3 MHz to 30 MHz to as an example 1 MHz to 100 MHz, arbitrary selection of switch type, using inductors and capacitors in sub-circuits versus solely inductors, using the antenna system for non-handheld purposes such as for portable or fixed station use and the number of sub-circuits used can be more or less than 5 as used in the preferred embodiment.

What is claimed is:

1. An antenna system comprised of a whip antenna and antenna tuner such that the antenna tuner is comprised of sub-circuits which can be combined in different combinations to tune the antenna system to different frequency bands; the sub-circuits are combined by switches with each switch connecting or disconnecting a single sub-circuit to the whip antenna; the switches connecting or disconnecting the sub-circuits to the whip antenna are controlled manually; at least one tuned frequency band of the antenna system, based upon switch combinations, is within the high frequency range of 3 MHz to 30 MHz.

2. The antenna system as defined in claim 1 such that each sub-circuit contains one or more inductors or capacitors; the sub-circuits are combined in series, in parallel or in both series and in parallel; the antenna system can be used handheld, that is without additional structural supports other than the handheld radio to which the antenna system is attached.

3. The antenna system as defined in claim 1 such that each sub-circuit is comprised of one or more inductors; each sub-circuit has a fixed inductance; the sub-circuits when combined are combined in series; the antenna system can be used handheld, that is without additional structural supports other than the handheld radio to which the antenna system is attached.
